(19) United States
(12) Patent Application Publication
(10) Pub. No.: US 2006/0067797 A1
(43) Pub. Date: Mar. 30, 2006

(54) End mill

(76) Inventor: Guy Allen Calamia, Gilroy, CA (US)

Correspondence Address: Robert P. Andris, ESQ, 1001 Marshall St., Redwood City, CA, 94063, US

(21) Appl. No.: 10/953,442

(22) Filed: Sep. 28, 2004

(51) Int. Cl. B23C 5/10

(52) U.S. Cl. 407/53

(57) ABSTRACT

An end mill with a peripheral margin which increases in width from the terminal end of the tool to the shank portion of the tool. The end mill also has a tooth face made up of three tooth-face walls The depth of the tool face gradually decreases from the terminal end to the shank portion of the tool. The end mill also has an end cutting face which includes a flat, narrow land at the outmost region of the end cutting end. The end mill has chip breakers with rounded peripheral corners. The end mill can be made up of ultra-fine micro grain tungsten carbide with a cobalt content which varies throughout the length of the tool.

### FIELD OF THE INVENTION

The present invention relates to the field of rotating end mills with multiple cutting surfaces.

### BACKGROUND OF THE INVENTION

For decades, end mills have been used with rotating milling cutters to cut, shape and finish a wide variety of ferrous and non-ferrous metals and alloys. These end mills are typically made of hardened steel.

U.S. Pat. No. 3,003,224 to Ribich discloses an end mill with two operating surfaces on the cutting face wall, as well as a primary and secondary tooth surface. According to Ribich, the secondary tooth surface on the cutting face of the end mill achieved a cleaner cut and a marked decrease of chip adherence to the cutting face surfaces.

U.S. Pat. No. 5,049,009 to Beck discloses an improved rotary cutting end mill which includes an arcuate shaped circular land on the first relief wall which contacts the cutting edge, as well as a slightly angled cutting end. According to Beck, this improved end mill achieved a decrease in the incidents of corner chipping and a reduction of operation noise. When made of tungsten carbide, this end mill was able to operate at high speeds without noise, wear or flute clogging.

However, while an improvement over prior end mills, the Beck end mill has several deficiencies and limitations. First, modern end mills running at high rpm's create tool deflection leading to catastrophic tool failure, unsatisfactory finishes and rejected work pieces. Second, the design of modern end mills creates a downward pressure on the end mill, forcing it to come out of its holder, again leading to tool deflection and catastrophic failure. Third, end mills with chipbreakers on their cutting edges consume more load power than non-chip breaker end mills and lead to chip packing in the flute. The chip size produced by such end mills is not conducive to clean machining because the over-sized chips tend to clog the work piece. More importantly, the large chip size created by these end mills hinders overnight, non-operator, operations because they tend to fill the chip receptacle bucket too quickly, thereby requiring the services of an operator to service the machine after hours.

The present invention provides significant, unexpected improvements to existing end mill cutting tools. First, the margin of an end mill is the unrelieved portion of the periphery of the land adjacent to the cutting edge. In existing end mills, the margin is of uniform width from the terminal end of each helical tooth as it spirals away from the end toward the shank portion of the end mill. The present invention includes a variable margin wherein the width of the land at the terminal end of each helical cutting tooth of the end mill gradually increases along the plane of the land as it spirals upward toward the shank section of the end mill. This variable margin on the peripheral cutting edge reduces tool deflection and catastrophic failure, thereby allowing the end mill to maintain higher speed rates throughout the cut. This aspect of the invention also greatly reduces the harmonic distortion created by existing end-mill cutters.

Second, as disclosed by Beck, modern end mills frequently include helical cutting teeth with two tooth face walls with each tooth of a uniform depth insofar as the distance from the peripheral cutting edge to the outside edge of the mill core is of a relatively uniform depth from the terminal end of the end mill as the teeth spiral toward the shank portion of the end mill.

The present invention provides for three tooth face walls and a variable depth tooth face wherein the depth of the tooth face is greatest at the terminal end of the cutting section of the end mill and less at the upper end of the helical cutting section. This allows the end mill to take a more aggressive or deeper cut when the end mill first touches the cutting surface. As the end mill cuts down into the work material, the gradual reduction in tooth face depth provides for a shallower cut with less force directed toward the upper portion of the cutting teeth where catastrophic failure frequently occurs. This variable tooth depth, especially in combination with the variable margin described herein, greatly reduces tool deflection and catastrophic failure, allows for higher feed rates and reduces the harmonic distortion created by existing end mill cutters.

Further, end mills in the prior art are manufactured with a dish which begins at the tip of the terminal cutting edge of each cutting tooth with a straight concave angle from the tip of the cutting edge face toward the axis of the end mill. Running at high speeds, this design results in tool deflection, squalls, chatter and vibration, particularly in the work piece's bottom finish in deep axial cuts and thin wall applications. The present invention includes a stabilizing flat land at the outer most region of the end cutting edge of the end mill. Depending on the diameter size of the end mill, this flat region is between 89° and 90° from the axis of the mill and extends inward from the tip of the end cutting face between 4 to 10 percent of the cutter diameter and then transitions into a concave angle toward the axial section of the tooth, thereby reducing and, at times, eliminating squalls, chatter and vibration, as well as a marked improvement in the work piece's bottom finish. Preferred embodiments of the invention include a straight and a curved dish.

Further, many steel turning tools are equipped with chip breaking devices to prevent the formation of long continuous chips in connection with the turning of steel or other work materials at high speeds. Long steel chips are dangerous to the operator, and cumbersome to handle, and they may clog or twist around the tool causing damage or increased maintenance. Broken chips, moreover, occupy less space and permit a better flow of coolant to the cutting edge. Typical chip breaker designs include angular shoulder type, parallel shoulder type and groove type.

With respect to groove type chipbreakers, the grooves in the prior art consist of depressions milled into the peripheral cutting teeth which are rounded on the sides and at the bottom but also have sharp 90° angles on their peripheral edges. These chipbreakers consume more power load than non-chip break end mills, create conditions limiting high speed machining and cause chip packing in the flute. The chip size created by these chipbreakers, moreover, hinders overnight, non-operator, operations because they tend to fill chip receptacles too quickly, thereby requiring the services of an operator to service the machine after hours.

The present invention includes a groove type chip breaker wherein the peripheral corners of the groove are rounded not sharp. By including rounded peripheral corners at this area of the groove, the end mill achieved more than a 30 percent improvement in load versus existing groove designs. The smaller chips produced by this design also results in reduced volume of chips and a freer cutting end mill that is able to remain stable at high machine rates.

Further, in a preferred embodiment, the present invention utilizes ultra-fine micro grain tungsten carbide materials with a cobalt content which varies throughout the length of the end mill. This allows for added strength and reduced costs while at the same time allowing for the high speed applications needed in today's marketplace.

### BRIEF DESCRIPTION OF THE DRAWINGS

FIG. 1 is a side view of an end mill embodying portions of the invention.

FIG. 2 is a cross-section of the helically fluted section of an end mill embodying portions of the invention.

FIG. 3 is an enlarged view of the end cutting edge of an end mill embodying portions of the invention.

FIG. 4A are enlarged portions of a side view of the terminal and upper sections of helically fluted cutting teeth embodying portions of the invention.

FIG. 4B is a side view of the helically fluted cutting teeth found in the prior art.

FIG. 5 is an enlarged cross section of the cutting edge of an end mill found in the prior art.

FIG. 6A is an enlarged cross section of the peripheral edge of a cutting tooth found near the terminal end of an end mill embodying portions of the invention.

FIG. 6B is an enlarged cross section of the tip of a cutting tooth near the upper end of the cutting section of an end mill embodying a portion of the invention.

FIG. 7A is a cross section of the terminal end of an end mill found in the prior art.

FIG. 7B is a cross section of the terminal end of an end mill embodying a portion of the invention.

FIG. 7C is a cross section of the terminal end of an end mill embodying a portion of the invention.

FIG. 8A is a cross section of an enlarged side view of a chip breaker found in the prior art.

FIG. 8B is an enlarged cross section of a side view of a chip breaker embodying a portion of the invention.

FIG. 9 is an end view of the end cutting edge of an end mill embodying portions of the invention.

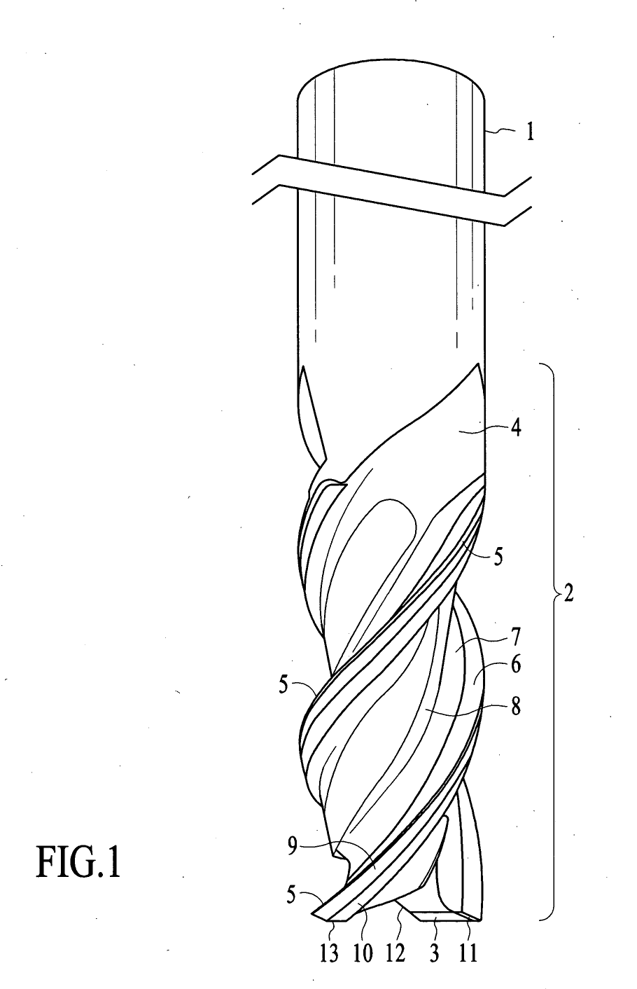

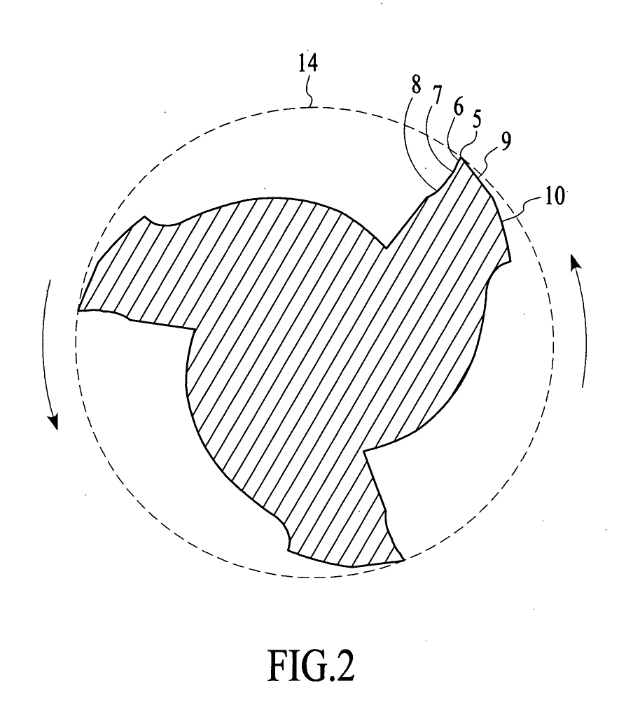

### DETAILED DESCRIPTION AND PREFERRED EMBODIMENTS

An improved helical, fluted single-end end mill is preferably made from ultra-fine micro grain tungsten carbide material with a cobalt content that varies from the top of the end mill to the bottom of the end mill. The end mill has a cylindrical shank 1, at least two helically fluted cutting teeth making up the helical cutting section of said end mill 2 said cutting teeth contain a tertiary tooth face 8, a secondary tooth face 7 and a primary tooth face 6.

Said cutting teeth also include a variable margin 5. In the prior art, the margin is the unrelieved part of the periphery of the land adjacent to the cutting edge. The margin width is the distance between the cutting edge and the primary relief see, 9, measured at a right angle to the cutting edge. Margin widths in the prior art are uniform from the terminal end of the cutting teeth on the margins entire length as it spirals upward toward the shank section of the end mill 15.

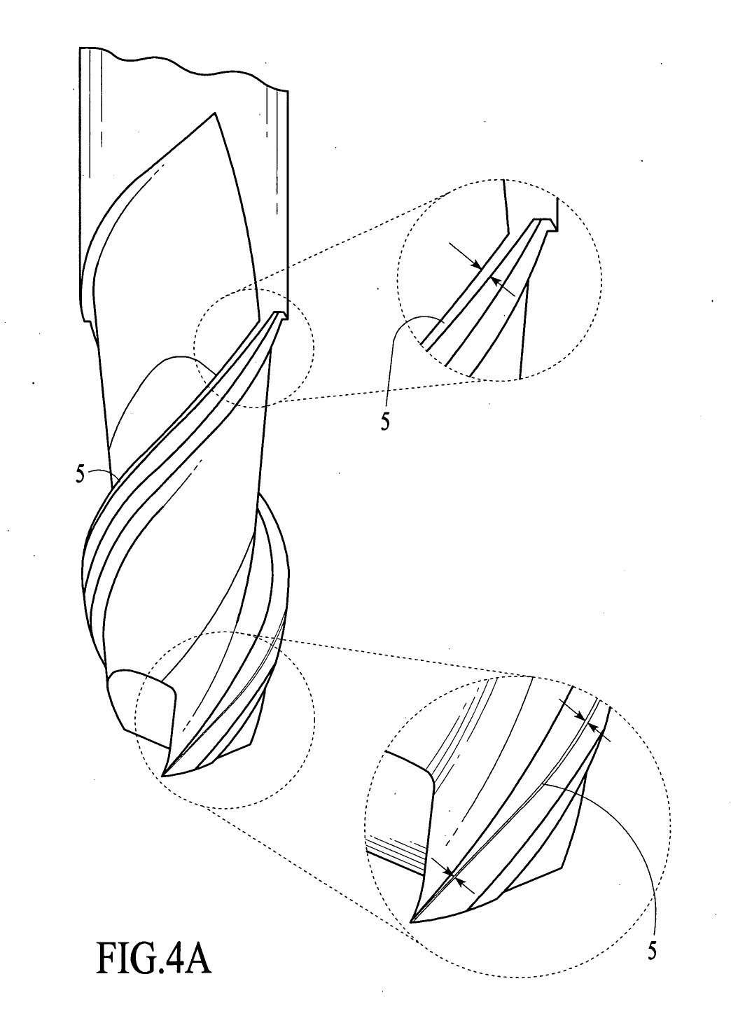

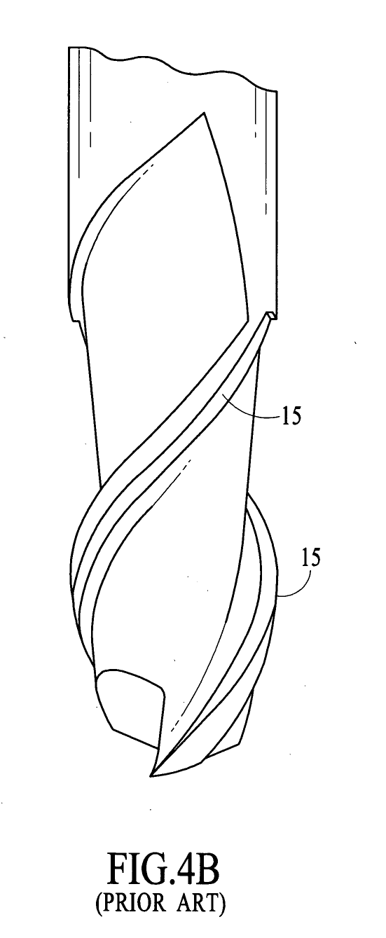

In the present invention, a variable margin is achieved wherein the margin width increases uniformly from the terminal end of the cutting tooth as the margin spirals helically toward the shank section FIG. 4A. It was discovered that this variable margin on the peripheral cutting edge reduces tool deflection and catastrophic failure, thereby allowing the end mill to maintain higher speed rates throughout the length of the cut. This aspect of the invention also greatly reduces the harmonic distortion created by existing and mill cutters.

A second improvement embodied in the invention is a tooth cutting face with three relief angles and a variable core or cutting tooth depth. Modern end mills frequently include helical cutting teeth with two tooth face walls with each tooth of a uniform depth as measured from the peripheral cutting edge to the outside edge of the mill core. The present invention provides for three tooth face walls 6, 7, and 8. Tooth depth is regulated by the removal of additional portions of the mill blank such that the peripheral edge of the cutting teeth is a uniform distance throughout the cutting section while the width of the core is variable.

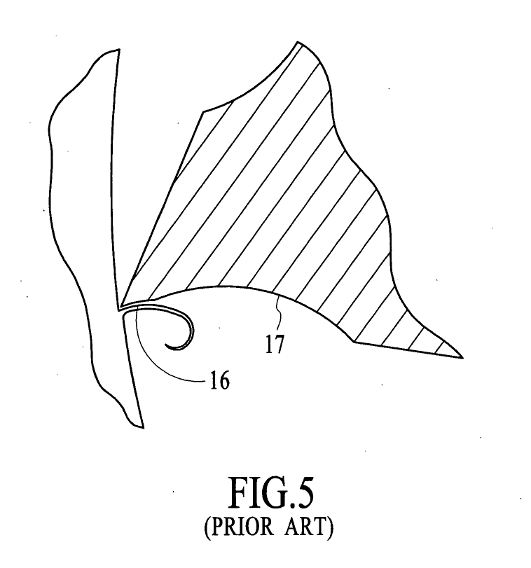

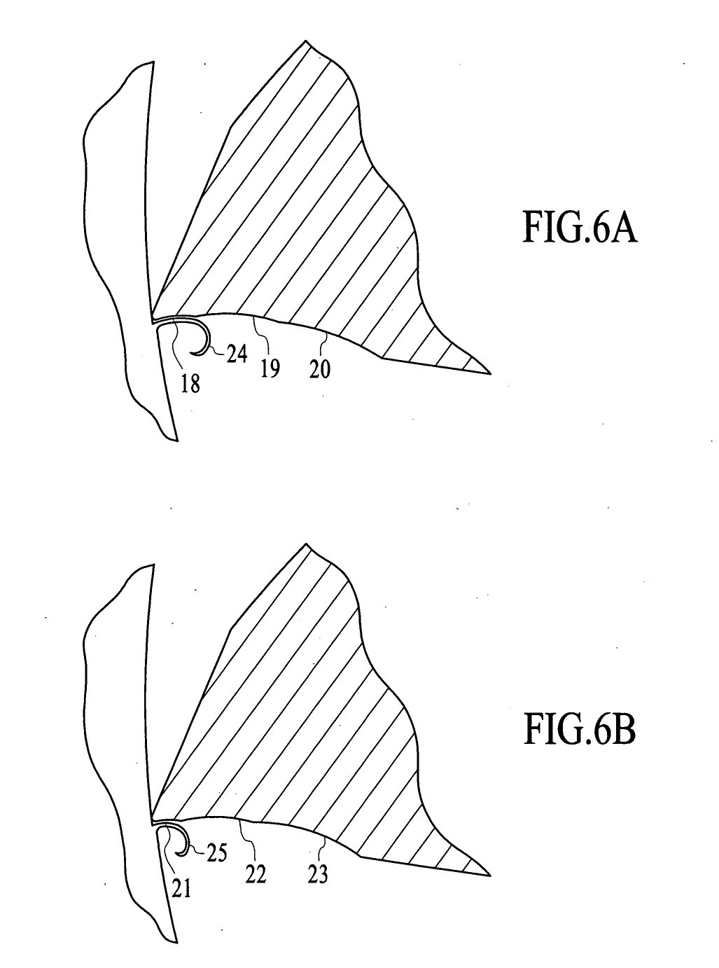

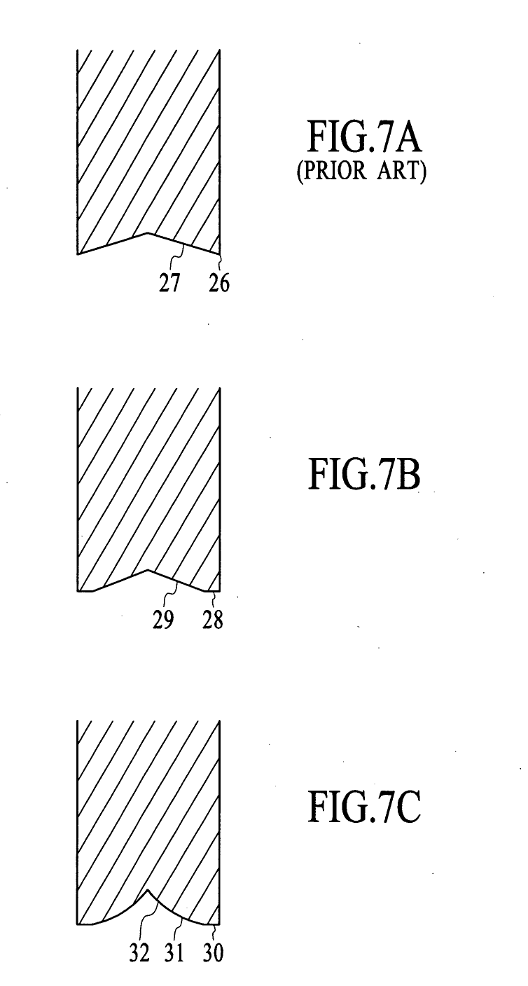

In its preferred embodiment, the variable tooth depth is greatest at the terminal end of the cutting section FIG. 6A and narrowest at the upper end of the cutting section near the shank FIG. 6B. The increased depth at the terminal end of the cutting section allows for more clearance for chip removal and allows for a wider primary tooth face 18 so as to allow for larger chip curls 24 and greater material removal at the terminal end of the mill and smaller primary tooth face widths at the upper section of the cutting area with concomitantly smaller chip curls 25 at the upper end of the cutting section. This improvement allows for higher feed rates and greatly reduces tool deflection and catastrophic failure, especially in combination with the variable margin described herein.

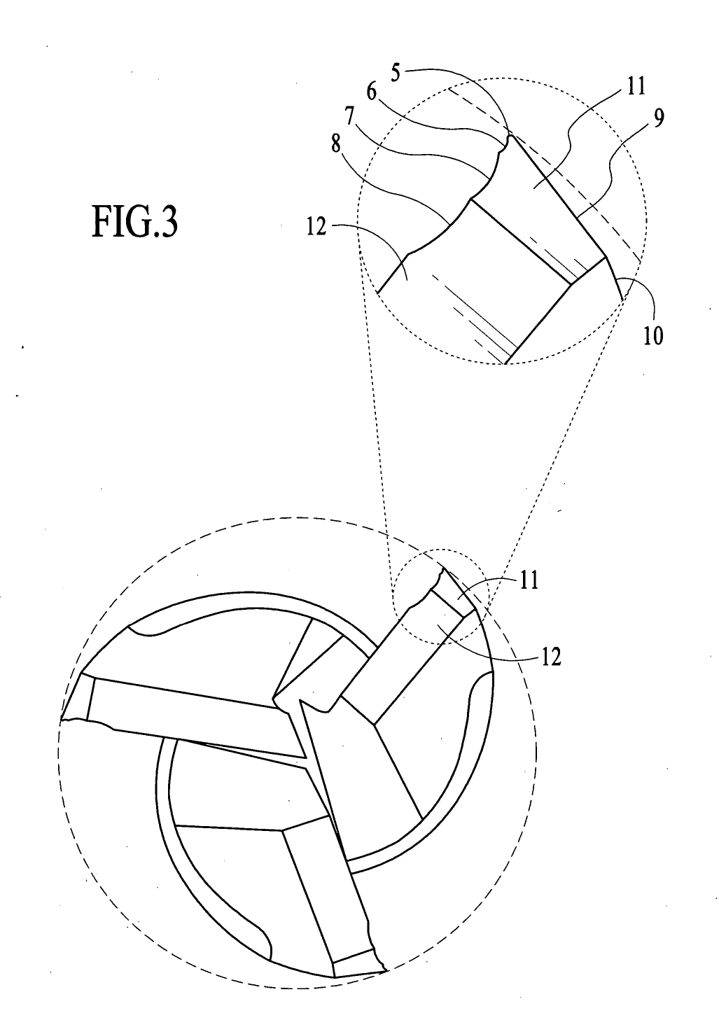

The present invention also is embodied in improvements to the end cutting edge (FIG. 3) of the end mill. This cutting face on the terminal end of the mill has traditionally consisted of an acute angle at the peripheral tip of each cutting tooth 26 which extends inwardly from the tip toward the axis of the end mill in a straight line 27. The present invention encompasses a flat region at the outer edge of each end cutting edge face 11 and 28. This end cutting end flat is between 89° and 90° from the axis of the mill and extends inward from the tip of the end cutting edge for between 4 to 10 percent of the cutter diameter. 11, FIG. 3.

The present invention also embodies a transitional angle inward and upward toward the axis creating an interior section of the cutter known as the dish 29, 31 and 32. One embodiment of the invention includes a dish made up of a straight line 29 and another embodiment includes a dish with a concave line 30, 31 and 32. This improvement reduces and, at times, eliminates squalls, chatter and vibration and also produces a marked improvement in the bottom finish of a work piece.

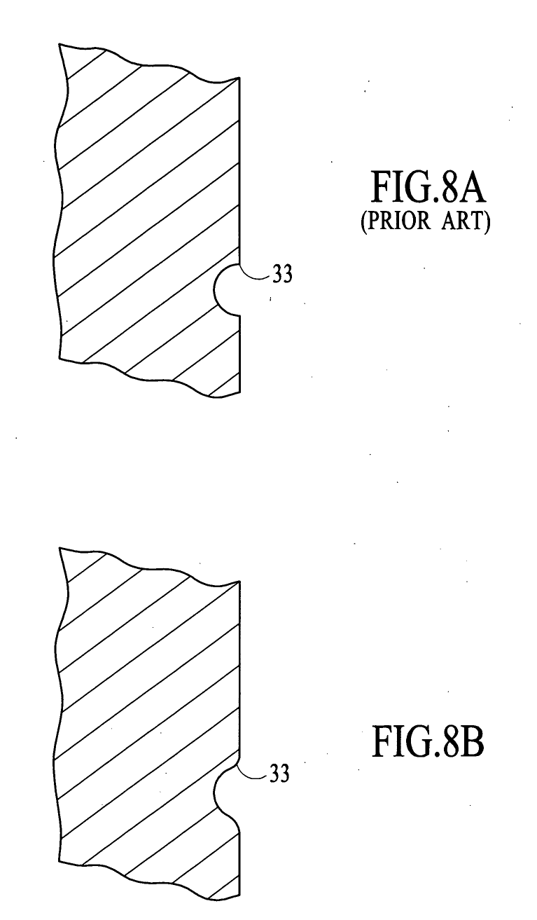

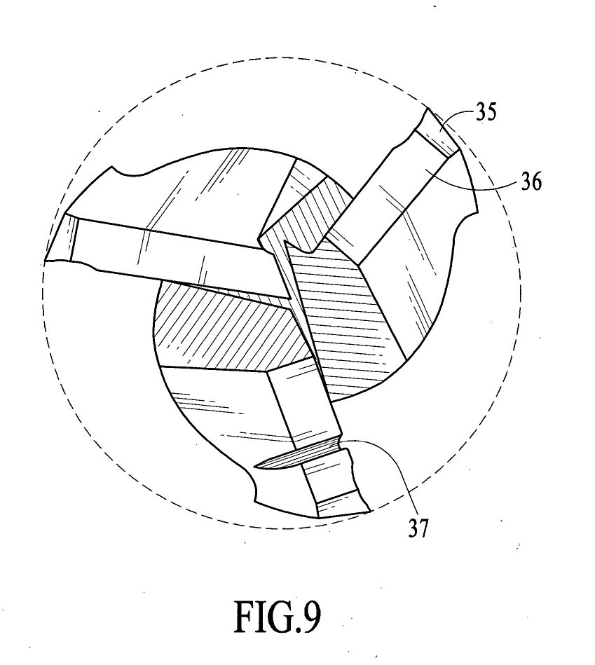

Yet another improvement embodied in the present invention is a unique design for grooved chipbreakers. The grooves found in traditional groove type chipbreakers consists simply of curved depressions milled into the peripheral cutting teeth, across the margin and through the primary and secondary relief walls. FIG. 8A. The peripheral edges of these traditional grooves initially form a straight 90° angle which then begins to curve inwardly and upwardly toward the opposite side of the groove.

As preferably embodied in the present invention, the peripheral corners of each groove are curved inwardly 34 instead of a 90° angle. These rounded or curved peripheral corners have resulted in achieving more than a 30 percent improvement in the load created by traditional chipbreaker devices. This improvement from the prior art also results in smaller chips which, in turn, results in reduced chip volume and a freer cutting end mill that is able to remain stable at high machine rates. In addition to being found on the peripheral edges of the cutting teeth, these chipbreakers can also be employed in the dish section of the end cutting edge 37.

Today's end mills are limited to four or less cubic inches per minute per horsepower of metal removal. The present invention allows for greater cubic inches per minute of metal removal per horsepower than any end mill on the market. This is achieved in part, because the invention allows more of the cutting flute to be engaged in the work material at very high speeds than previous inventions. The invention demonstrates that cubic inch/minute metal removal rates exceeding five per horsepower are common. In some instances, the invention demonstrates the ability to achieve 8.01 cubic inches per minute, per horsepower.

Further, a preferred embodiment of the present invention utilizes ultra-fine microgram tungsten carbide materials with a cobalt content which varies throughout the length of the end mill. The use of this type of material allows end mill manufacturers to add or decrease strength and rigidity in the end mill itself to reduce the cost of the end mills, while at the same time allowing the manufacturer to design mills with added strength in either the terminal end or lower shank sections to meet desired applications. Moreover, by utilizing the aforementioned materials, manufacturers can create a mill which facilitates adhesion of diamond-based coatings of the cutting teeth for use in extremely hard work materials.

While this invention has been described in its best mode and preferred embodiment, these descriptions have been made by way of example only. The invention is not limited to said best modes and preferred embodiments, but rather must be measured by the scope and spirit of the appended claims.

What is claimed is:

1. An improved helical, fluted single-end end mill having a shank section, which is retained in a rotary driven apparatus, and a helically fluted cutting section, the terminal end of said fluted section at the opposite end of said shank section, one or more helical teeth formed on the outer surface of said fluted section, each tooth comprising a multi-faceted tooth face, a peripheral cutting edge, a margin, a radial relief section and a clearance surface, wherein the improvement comprises:
a variable margin on said helical cutting teeth such that the margin is most narrow at the terminal end of each of said helical cutting teeth and widest at the upper end of said teeth.

2. The improved end mill recited in claim 1 wherein the upper end of said variable margin is between 1.2 and 3 times wider than the width of the margin at the terminal end of said helical cutting teeth.

3. The improved cutting mill recited in claim 2 wherein the width of the variable margin increases in a uniform fashion from the terminal end of said cutting section to the upper end of said cutting section.

4. The improved end mill recited in claim 3 wherein said end mill is made from ultra-fine micro grain tungsten carbide material with a cobalt content that varies from the top of the end mill to the bottom of the end mill.

5. An improved helical, fluted single-end end mill having a shank section, which is retained in a rotary driven apparatus, and a helically fluted cutting section, the terminal end of said fluted section at the opposite end of said shank section, one or more helical teeth formed on the outer surface of said fluted section, each tooth comprising a multi-faceted tooth face, a peripheral cutting edge, a margin, a radial relief section and a clearance surface, wherein the improvement comprises:
a variable depth multi-faceted tooth face wherein the depth of the tooth face is greatest at terminal end of the cutting section and least at the upper portion of said helical cutting teeth.

6. The improved end mill recited in claim 5 wherein said tooth face at the terminal end of the cutting section is between 1 percent and 100 percent deeper than the depth of the tooth face at the upper end of said helical cutting teeth.

7. The improved end mill recited in claim 6 wherein the depth of the tooth face decreases in a uniform fashion from the terminal end of said cutting section to the upper section of said cutting section.

8. The improved end mill recited in claim 7 wherein said end mill is made from ultra-fine micro grain tungsten carbide material with a cobalt content that varies from the top of the mill to the bottom of the mill.

9. An improved helical, fluted single-end end mill having a shank section, which is retained in a rotary driven apparatus, and a helically fluted cutting section, the terminal end of said fluted section at the opposite end of the shank section, one or more helical teeth formed on the outer surface of said fluted section, each tooth compromising a two face, a peripheral cutting edge, a radial relief section, and a clearance surface wherein the improvement comprises:
an end cutting edge of each of said helical teeth wherein said terminal face is comprised of a flat outer most region which is between 89° and 90° from perpendicular to the axis of the end mill and an inner region with a concaved angle.

10. The improved end mill recited in claim 9 wherein the length of said flat outer most region is between 0.005 and 0.100 inches.

11. The improved end mill recited in claim 10 wherein the concave angle of said inner most region is between 170 to 178 degrees.

12. The improved end mill recited in claim 11 wherein the dish is a straight line.

13. An improved helical, fluted single-end end mill having a shank section, which is retained in a rotary drive apparatus, and a helically fluted cutting section, the terminal end of said fluted cutting section at the opposite end of the shank section, one or more helical teeth formed on the outer surface of said fluted section, each tooth comprising a two face, a peripheral cutting edge, a radial relief section and a clearance surface wherein the improvement comprises:
an end cutting edge of each of said helical teeth wherein said end cutting edge is comprised of an arcuate concave curve which draws an upard angle of between 170 and 178°.

14. The improved end mills recited in claims 12 or 13 wherein said end mill is made from ultra-fine micro grain tungsten carbide material with a cobalt content that varies from the top of the mill to the bottom of the mill.

15. An improved helical, fluted single-end end mill having a shank section, which is retained in a rotary drive apparatus, and a helically fluted cutting section, the terminal end of said fluted cutting section at the opposite end of the shank section, one or more helical teeth formed on the outer surface of said fluted section, each tooth comprising a two face, a peripheral cutting edge, a radial relief section and a clearance surface wherein the improvement comprises:
one or more grooved chipbreakers wherein the upper corners of said groove are rounded.

16. The improved end mill recited in claim 15 wherein said end mill is made from ultra-fine micro grain tungsten carbide material with a cobalt content that varies from the top of the mill to the bottom of the mill.

17. The features of the improved end mill recited in claim 3 combined with the features of the improved end mill recited in claim 7.

18. The improved end mill recited in claim 3 combined with the features of the improved end mill recited in claims 12 or 13.

19. The improved end mill recited in claim 3 together with the improvements recited in a claim 15.

20. The improved end mill recited in claim 17 combined with the improvements recited in claims 12 or 13.

21. The improved end mill recited in claim 17 together with the improvements recited in claim 19.

22. The improved end mills recited in claim 20 together with the improvements recited in claim 15.

23. The improved end mills recited in claims 17, 18, 19, 20, 21 or 22 wherein said end mills is made from ultra-find micro grain tungsten carbide material with a cobalt content that varies from the top of the mill to the bottom of the mill.
